(19) United States
(12) Patent Application Publication
(10) Pub. No.: US 2013/0060778 A1
(43) Pub. Date: Mar. 7, 2013

(54) DEVICE, METHOD, AND PROGRAM FOR DISPLAYING DOCUMENT LIST

(71) Applicant: Kazunari Yamanakajima, Kawasaki-shi (JP)

(72) Inventor: Kazunari Yamanakajima, Kawasaki-shi (JP)

(73) Assignee: CANON KABUSHIKI KAISHA, Tokyo (JP)

(21) Appl. No.: 13/601,403

(22) Filed: Aug. 31, 2012

(30) Foreign Application Priority Data
Sep. 7, 2011 (JP) 2011-195399

(51) Int. Cl. G06F 17/30

(52) U.S. Cl. 707/737; 707/E17.089

(57) ABSTRACT

Provided are a device, a method, and a program for displaying a document list with which a desired document can be effectively specified. The present invention groups documents in accordance with a displaying method of a document list, dynamically gives a group a name with which a range of the grouped documents can be seen, and organizes the document list.

### BACKGROUND OF THE INVENTION

1. Field of the Invention

The present invention relates to a device, a method, and a program for displaying a document list.

2. Description of the Related Art

A large amount of documents stored in a document management server or locally stored are hierarchized to be organized in a storage area in order to facilitate access to a desired document. Additionally, the organized document is generally displayed by a tree view and a list view.

In contrast, the document management server has a mechanism of automatically storing a file, and there is a case where a large amount of files are stored in one storage area. In such a situation, in the tree view and the list view, there are some cases where displaying becomes slow due to a large amount of documents, or the documents cannot be displayed. In addition, even if a large amount of documents can be displayed, it takes time and effort for a user to search for a desired document among a document list.

In contrast to this, as a conventional technology, for example disclosed in Japanese Patent Laid-Open No. 2006-079552, there has been known a technology which has a function of automatically hierarchizing a large amount of documents stored to be organized.

### SUMMARY OF THE INVENTION

However, since, in a prior technology, documents are hierarchized to be organized regardless of a displaying method of a document list, a user may not easily search for a desired document.

Consequently, an information processing device according to the present invention is the information processing device having a storage section and a processor, which solves the above-described problem by including: a unit configured to group files stored in the storage section into a first group in accordance with a feature of the files and to further group the files of the first group into a second group by a predetermined number of files by the processor; and a unit configured to determine names of the first and the second groups in accordance with the feature of the files included in the groups by the processor.

Accordingly, the present invention makes it possible to provide a device, a method, and a program for displaying a document list with which a desired document can be effectively specified.

Further features of the present invention will become apparent from the following description of exemplary embodiments (with reference to the attached drawings).

### BRIEF DESCRIPTION OF THE DRAWINGS

FIG. 1 is a diagram showing a configuration content of a computer in one embodiment of the present invention;

FIG. 2 is a diagram showing a network configuration in one embodiment of the present invention;

FIG. 3 is a block diagram showing a functional configuration of an application program in one embodiment of the present invention;

FIG. 4 is a view showing an example of a display screen of a document list;

FIG. 5A is a view showing an example of a display screen of a document list by display groups;

FIG. 5B is a view showing an example of a display screen of a document list in which a display group is expanded;

FIG. 6A is a view showing an example of display groups when sorted by update dates and times;

FIG. 6B is a view showing an example of an expanded display group when documents are sorted by update dates and times;

FIG. 7 is a table in which display groups are collected for each data type;

FIG. 8A is a view showing an example of display groups when sorted by extensions;

FIG. 8B is a view showing an example of expanded display groups when sorted by an extension;

FIG. 9 is a view showing display groups collected by extensions and the number of documents;

FIG. 10 is a diagram showing the relationship between FIG. 10A and FIG. 10B;

FIG. 10A is a flow chart of display group creation processing;

FIG. 10B is a flow chart of display group creation processing;

FIG. 11 is a view showing an example of documents associated by document names;

FIG. 12 is a view showing an example of a naming convention definition of a document;

FIG. 13A is a view showing an example of display groups created based on document names;

FIG. 13B is a view showing an example of expanded display groups created based on document names;

FIG. 14 is a view showing an example of a creation method definition file of a display group; and

FIG. 15 is a view showing an example where document files and display groups which are likely to be referred to are mixed.

### DESCRIPTION OF THE EMBODIMENTS

Hereinafter, the best mode for carrying out the present invention will be described using drawings. However, components described in this embodiment are mere exemplifications, and the scope of the invention is not intended to be limited thereto.

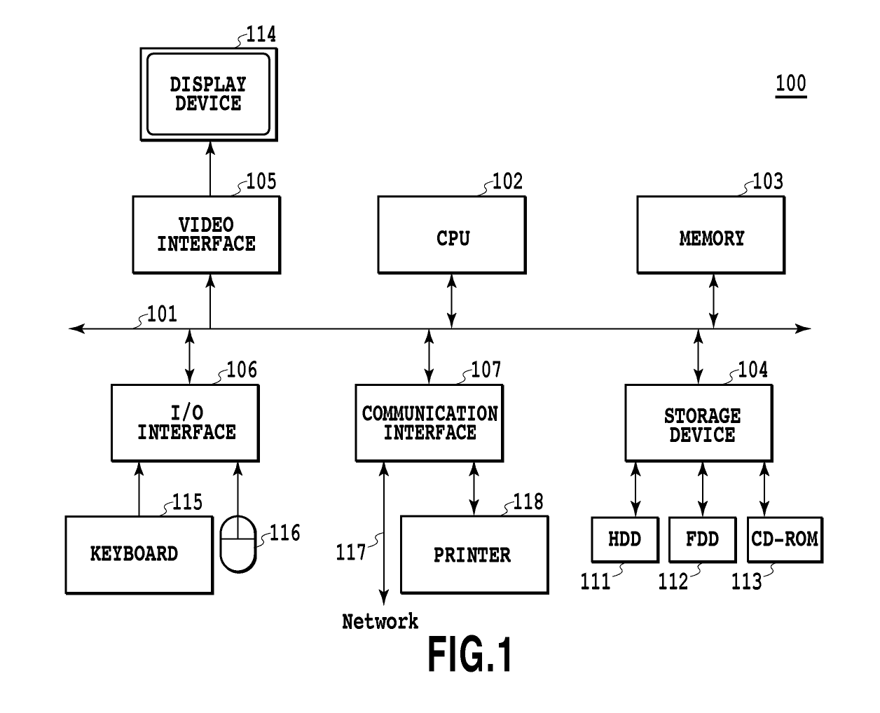

FIG. 1 is a diagram showing a configuration of an information processing device according to one embodiment for carrying out the present invention. In FIG. 1, an information processing device 100 is provided with a CPU 102, a memory 103; a storage device 104, a video interface 105, an Input/Output (hereinafter abbreviated as I/O) interface 106, and a communication interface 107. In addition, each component in the information processing device 100 is connected to each other via a system bus 101.

The CPU102 is a central processing unit which controls each component through the system bus 101, and performs calculating and processing of data. The memory 103 is a device which stores data and a program, and is configured with a RAM (Random Access Memory) and a ROM (Read Only Memory). The storage device 104 performs write/read of stored data. The storage device 104 includes an HDD (hard disk drive) 111, an FDD (floppy (registered trademark) disk drive) 112, and a CD-ROM drive 113 utilized as a nonvolatile data source. Although not shown in FIG. 1, a magnetic tape drive, a DVD-ROM, a USB memory, etc. may also be used as the storage device 104.

A program according to the present embodiment is read from the storage device 104, is stored in the memory 103 and subsequently, is executed by the CPU102. It should be noted that in the present embodiment it is configured to read the program from the storage device 104, but is not limited to this. For example, there may be employed such a configuration that the program is read from the ROM (not shown), or is read from the outside via the communication interface 107.

The video interface 105 controls a display output to the display device 114. There may be some display devices 114 using schemes such as a CRT and a liquid crystal. Input devices such as a keyboard 115 and a pointing device 116 are connected to the I/O interface 106. An operator gives an operation instruction etc. to the information processing device 100 by operating the keyboard 115. The pointing device 116 is configured to move a cursor displayed on the display device 114 and to perform selection, operation, etc. of a menu or an object. The communication interface 107 is configured to communicate with an external equipment through a computer network 117. A destination of the computer network may be a public network such as a LAN, a WAN, and the Internet, etc. Furthermore, the communication interface 107 also is configured to communicate with output equipments such as a local printer 118.

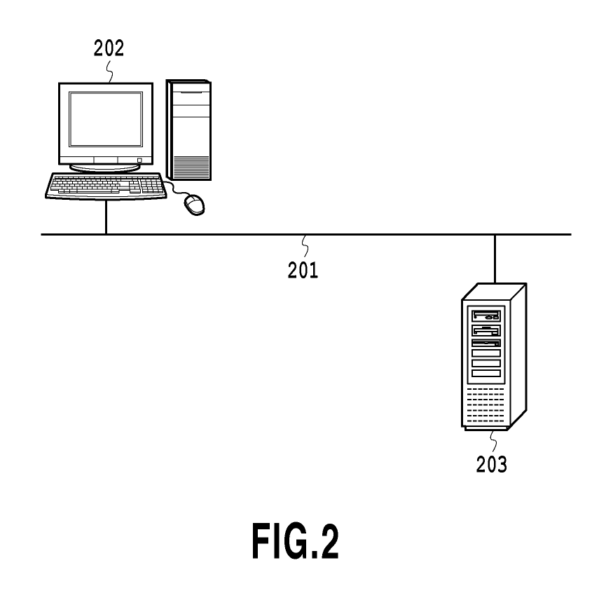

FIG. 2 is a network configuration diagram according to the present embodiment. A client personal computer (hereinafter abbreviated as a client PC) 202 and a server computer (hereinafter abbreviated as a server) 203 are connected to a computer network 201. The computer network 201 includes a LAN, a WAN, the Internet, etc. The client PC 202 performs communication with the server 203 through the computer network 201. It should be noted that in the present embodiment, both the client PC 202 and the server 203 are assumed to have a configuration similar to the configuration of the information processing device 100 shown in FIG. 1. However, the configuration of the client PC 202 and the server 203 is not limited to the configuration in FIG. 1, it may be provided with other functions.

Subsequently, an application program according to the present embodiment will be described. It should be noted that in the present embodiment, a mode is assumed in which a document management server which is an application program mainly operates on the server 203, transmits to the client PC 202 information of a list of documents stored in the document management server, and the list of the documents is displayed on the client PC 202. However, the embodiment is not limited to such mode, and a mode can also be employed in which storage of documents and display of the document list operate on a same PC.

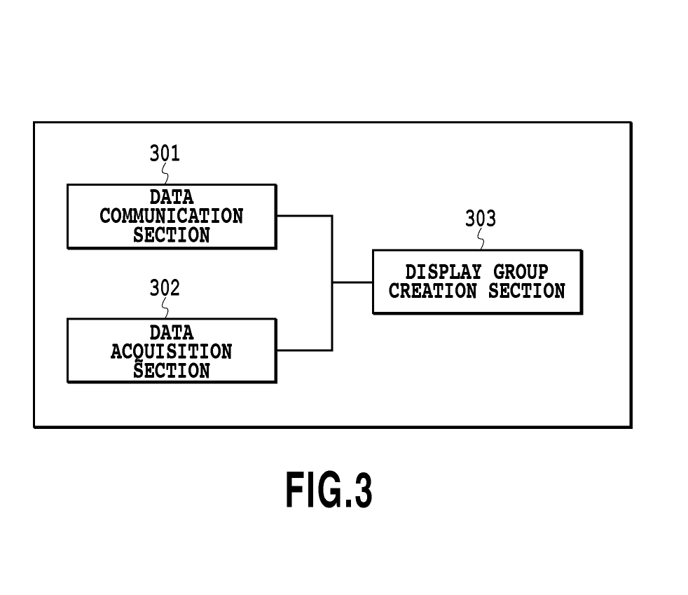

FIG. 3 is a functional block diagram of a document management server according to the present embodiment. A data communication section 301 performs communication with a client PC. For example, the data communication section 301 receives a document list acquisition instruction from the client PC, or transmits a result of an acquired document list to the client PC. A data acquisition section 302 extracts a document serving as a target of the instruction among documents stored in the storage device 104 of the server 203. A display group creation section 303 creates a group (hereinafter referred to as a display group) for collectively displaying a plurality of documents based on the information acquired by the data acquisition section 302.

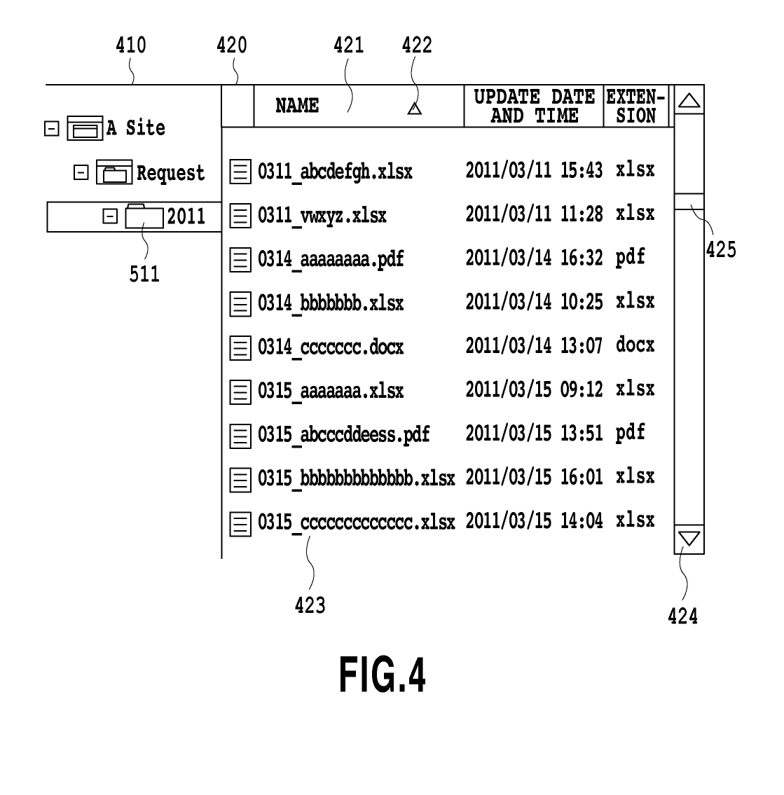

FIG. 4 shows one example of a display screen of a document list in the client PC. Documents stored in the storage device 104 of the document management server (server 203) are stored in a hierarchically divided storage area (a folder or a cabinet). A numeral 410 denotes a tree view indicating a hierarchical storage area on the server. When a hierarchical storage area indicated by the tree view 410 is clicked, a list of documents stored in the storage area is displayed on a list view 420. On the list view 420, a column index 421, a document list 423, and a scroll bar 424 are arranged. The column index 421 indicates what each column of data displayed by the document list 423 means.

Furthermore, when the column index 421 is clicked, data can be sorted in ascending order or descending order. For example, when a name column is clicked, an instruction of sorting data in a nominal order is transmitted to the server, data sorted in the nominal order is acquired by the server and subsequently, the client PC receives the data to display on the list view 420. At that time, it is a sort identification display 422 that indicates a column sorted. Sorting can be performed not only by the name column, but by an update date and time column or an extension column. The scroll bar 424 is displayed when the document list cannot be fitted inside a screen, and a function for accessing all the documents is provided by operating a slider 425.

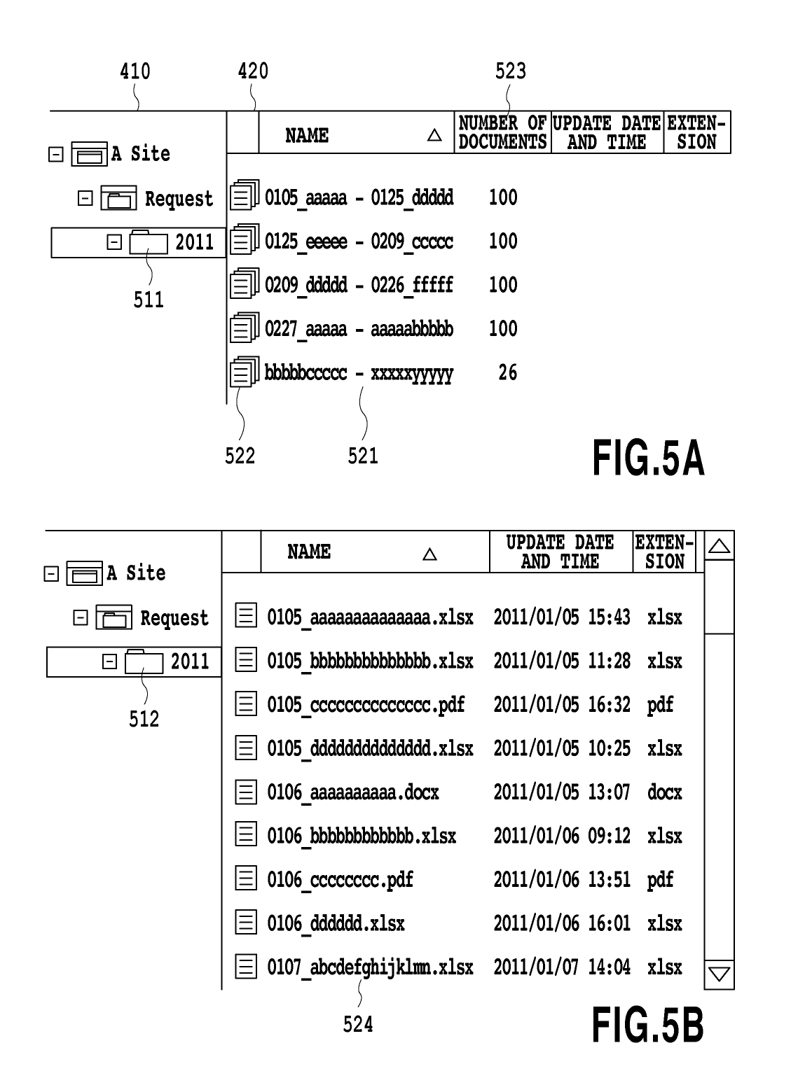

Although displaying a list of a plurality of documents can be performed in the list view of FIG. 4, a problem may occur in which it takes time and effort to search for a desired document from the list, or display becomes slow because of lots of information to communicate with the server due to a number of displayed documents, when a large amount of documents are stored in one storage area. A solution to the problem will be described in FIG. 5 or subsequent figures.

FIG. 5A is a view showing display of a document list by display groups. A document list 521 displays display groups when documents are grouped by 100 units. It is assumed that 426 document files are stored in a document storage area (folder) 511. The display groups created by grouping documents by 100 document units in a sorted nominal order are displayed on a document list 521. It should be noted that documents are collected by 100 document units in an example shown in FIG. 5A, but the number of documents to be collected is not limited to 100 documents. That is, documents may be grouped by the arbitrary number of documents, such as the number of documents calculated from a set value or a total number of documents.

In addition, each display group name is the name from which a grouped range can be seen. A display group name is assumed to be given based on an index used for sort. Since documents are sorted by names in the example shown in FIG. 5A, the display group name is given based on document names of documents included in each display group. For example, a display group “0105_aaaaa-0125_ddddd” located on a top of the document list 521 indicates a group range by cutting out ten initial characters of names of a leading document and a trailing document of the group, respectively, and couples them with hyphens. A list from which a group including a desired document can be seen is provided by indicating the group range. An icon 522 indicates that a content of the list is not a single document, but a display group. In addition, a column 523 is the column specially displayed when a document list has a display group, and indicates the number of document files in the display group.

An amount of communication data from the server to the client is reduced by displaying documents in a state of being grouped as described above, thereby leading to the improvement of a display speed.

FIG. 5B shows a document list when one of the display groups of the document list 521 shown in FIG. 5A is expanded. A document list 524 represents a document list when a display group “0105_aaaaa-0125_ddddd” is expanded, and grouped 100 documents are displayed in the document list 524. It should be noted that a storage 512 of the tree view is displayed similar to the storage 511 in FIG. 5B, but is not limited to this, and that display groups may be displayed by a tree structure under a hierarchy of the storage 512.

As described above, document files are grouped, a group name is determined in accordance with a feature of the files (file name), and thus it becomes easy for a user to access a desired document file.

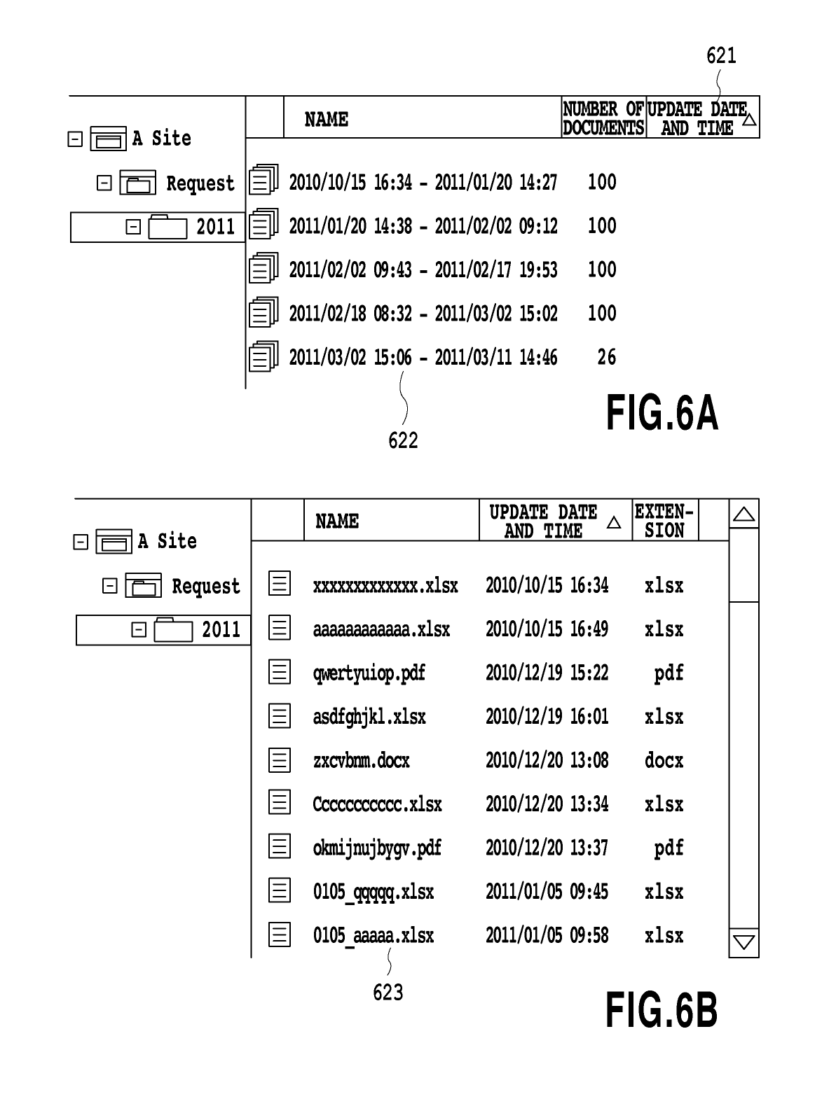

FIG. 6A is a view showing a document list by display groups when sorted in update dates and times. Although a document list 622 is the list in which documents are grouped by 100 units similar to the document list 521 of FIG. 5A, a sort order is based on update dates and times in the document list 622. In this case, a name of the display group indicates a group range by the update dates and times. For example, a display group “2010/10/15 16:34-2011/01/20 14:27” on a top of the document list 622 indicates a group range by coupling update dates and times of a leading document and a trailing document in the display group. A column index 621 indicates that display groups have been sorted by update dates and times.

FIG. 6B shows a document list when a display group of the document list 622 shown in FIG. 6A is expanded. A document list 623 represents a document list when a display group “2010/10/15 16:34-2011/01/20 14:27” is expanded, and grouped 100 documents are displayed in the document list 623.

In FIGS. 5 and 6, display groups when sorted by each of names and update dates and times are shown, but the embodiment is not limited to this, and various values can be displayed on a column of the list view.

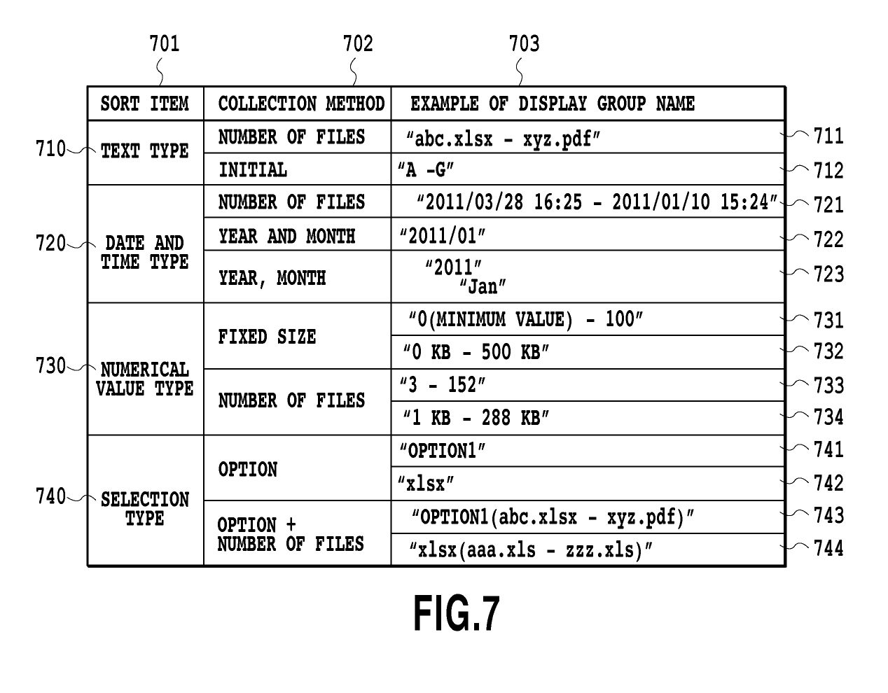

FIG. 7 is a table showing a collection method of documents, when values of various columns (index items) are classified depending on general data types and the documents are grouped by the respective data types. Hereinafter, a display group for each data type will be described with reference to FIGS. 7 to 10.

A numeral 701 of FIG. 7 is a column indicating data types of sort items (index items used for sort). Numerals 710, 720, 730, and 740 indicate that targets to be sorted are a text type, a date and time type, a numerical value type, and a selection type, respectively. A numeral 702 indicates grouping methods when documents are sorted by the sort item 701. A numeral 703 indicates examples of names given to display groups when documents are grouped.

Name mentioned in FIG. 5 is included in examples of the text type 710. There are two types of collection methods of the text type 710 as shown in the numerals 711 and 712. An example of collecting documents by the number of files as the numeral 711 is the same as described in FIG. 5.

When documents are collected by initials as the numeral 712, ranges are divided by the initials and then the documents are grouped. For example, a name indicating a range of the initials as “A-G” is then given as a display group name. In the case of the numeral 712 in which documents are collected by initials, although the number of files of each display group does not need to be the same, the documents may also be divided also in consideration of the number of files. Accordingly, when documents are collected by initials, and when documents are divided by the number of files, initials displayed as a display group name “A-G” and a subsequent display group name “G-L” overlap. In addition, when files having file names of the same initials exceed the predetermined number (for example, a hundred), subgrouping may be further performed. As a name of such a subgroup, a name in accordance with an initial and a subsequent character may be used.

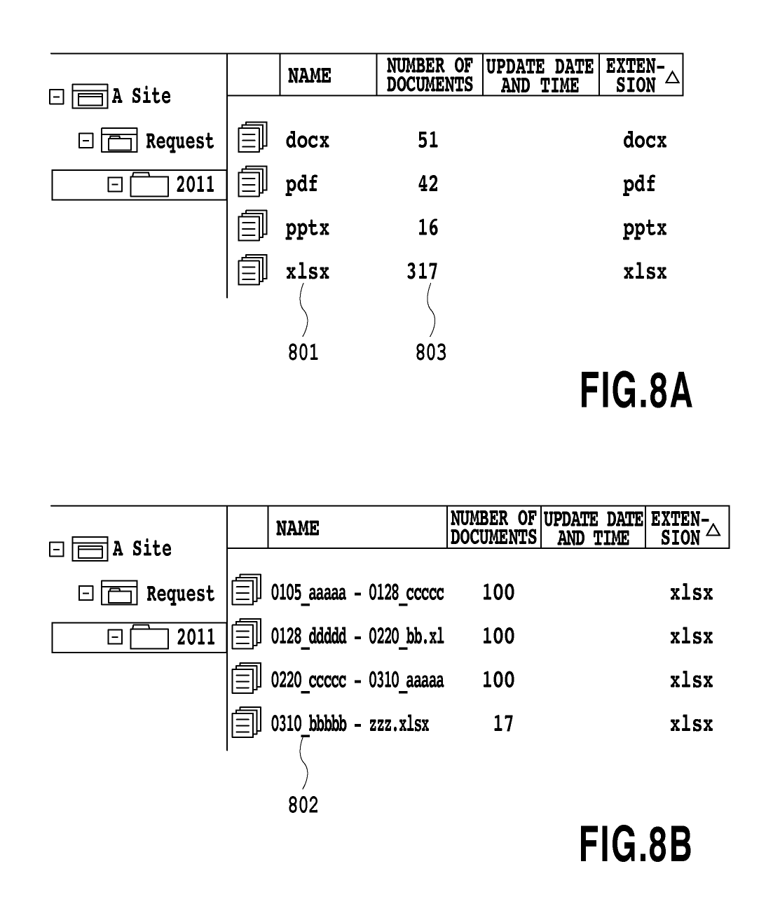

Update date and time mentioned in FIG. 6 is included in examples of the date and time type 720. There are three types of collection methods of the date and time type 720 as shown in the numerals 721, 722, and 723. An example of collecting documents by the number of files as the numeral 721 is the same as described in FIG. 6. When documents are collected by year and month of the numeral 722, the documents are collected by the month unit also including a year. In this case, the number of files of each display group basically differs. A numeral 723 indicates a case where a year and a month are collected in two stages. That is, display groups are hierarchized. Documents are collected as a display group of the year “2011” as in an example, and documents are collected as a display group of the month as “Jan” under a hierarchy of the display group of the year “2011”. An example where display groups are hierarchized will be described later by using FIG. 8. It should be noted that although grouping by a year and a month has been described as for the numerals 722 and 723, grouping may be performed by the date and time unit depending on a creation amount of document files.

A numerical value type 730 is the type in which attribute values are numerical values. In examples of the numerical type 730, a file size and the number of pages are included. A collection method of the numerical value type 730 includes a case where documents are collected by a certain size as numerals 731 and 732, and a case where documents are collected by the number of files as numerals 733 and 734. A name of a display group is determined depending on a file size etc.

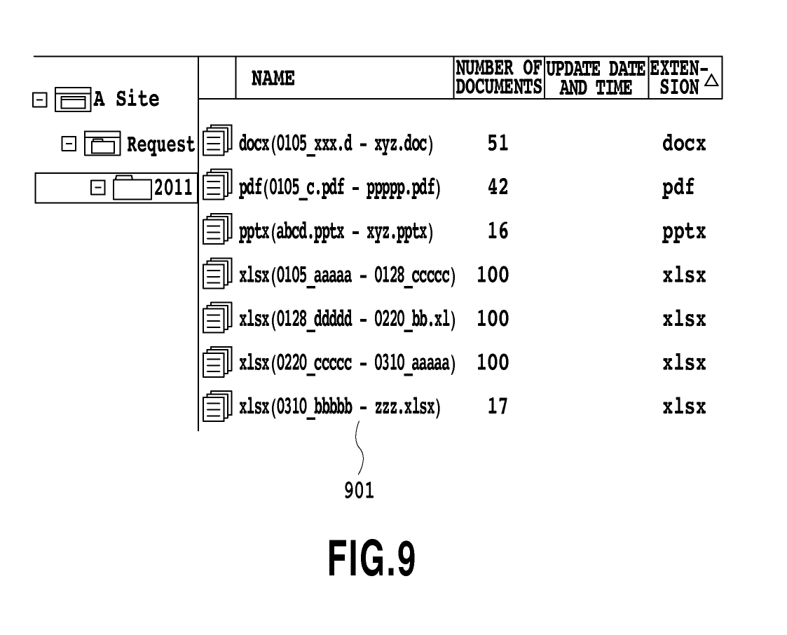

The selection type 740 is the type in which attribute values can be classified into several types and options. In examples of the selection type 740, an extension of a file is included. A collection method of the selection type 740 includes a case where documents are collected only by options as numerals 741 and 742, and a case where documents are collected in combinations of options and the number of files as numerals 743 and 744. Examples of screens of the numerals 742 and 744 will be described with reference to FIGS. 8 and 9, respectively.

The numeral 742 of FIG. 7 indicates a case where documents are collected by an extension as an example of the selection type. A document list 801 in FIG. 8A indicates a display group list collected for each extension. That is, document files are grouped by file types. In addition, each grouped display group (a first group) is named depending on a file type.

Options are enumerated in the document list as described above, and an option with a number of document files may be enumerated as a bottom display group “xlsx”. In such a case, a display group (a second group) in which documents are collected by the number of files is further created under the display group. FIG. 8B shows a document list when the display group “xlsx” of the bottom in FIG. 8A is expanded. In a document list 802 in FIG. 8B, documents are collected by the predetermined number of files unit (a hundred units in this example), and thus display groups are created. In this example, a name of the second group is determined depending on file names of files included in the group.

The collection methods other than a collection method by the number of files have been described in FIG. 7, and when a number of document files are included in the display group as described above, a large amount of document files are prevented from being displayed on a list at a time by the fact that documents are eventually collected by the number of files. It should be noted that the number of documents indicated by the numeral 803 in FIG. 8A may display the number of document files, and may display the number of display groups located directly below. For example, although the display group “xlsx” of the document list 801 is displayed as 317 if it is the number of subordinate document files, it may be displayed as 4 which is the number of display groups directly below.

Next, the numeral 744 of FIG. 7 will be described with reference to FIG. 9. The numeral 744 is a combination of grouping by options and grouping by the number of files, and in the above-mentioned example of the numeral 742, two-stage display groups are indicated as one stage display groups. In a document list 901 in FIG. 9, documents are not only grouped for each extension, but also groups with a number of document files are further divided based on the number of files. Names of the display groups are also the names in combination of extensions and ranges of the documents. It should be noted that, although names of display groups which is divided by the number of files are also attached with ranges of the documents in the document list 901, the ranges of the documents are not required to be attached with the names.

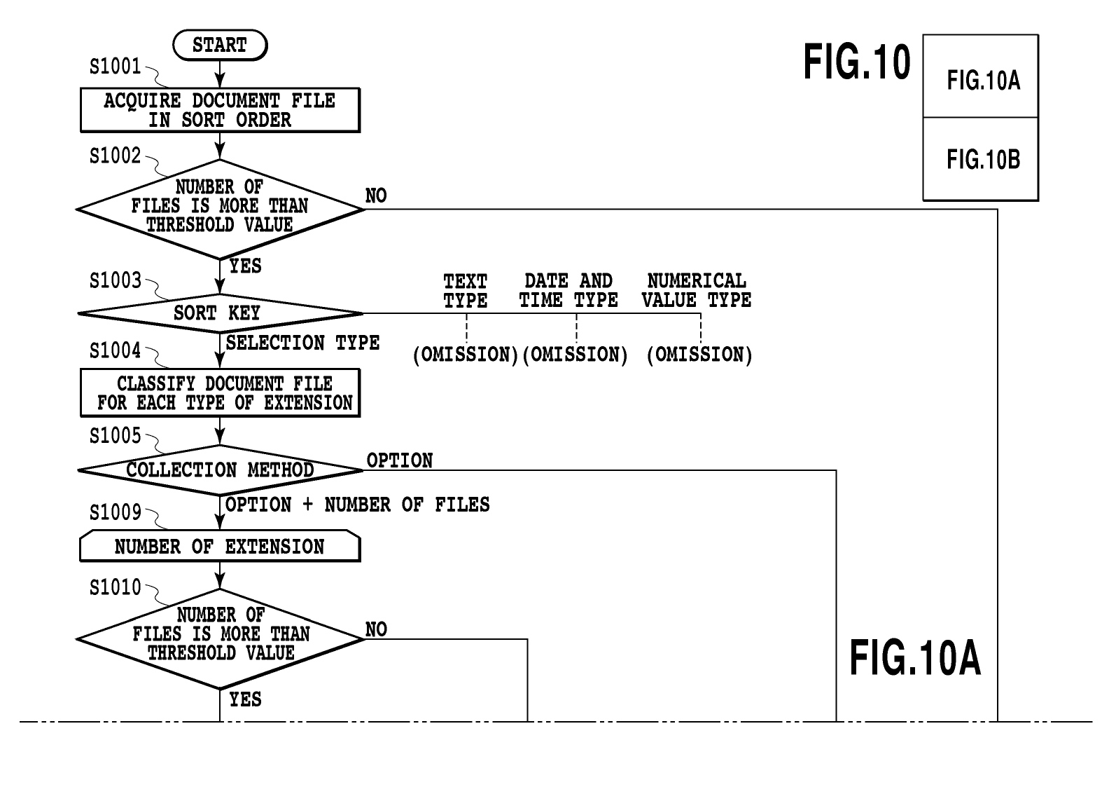

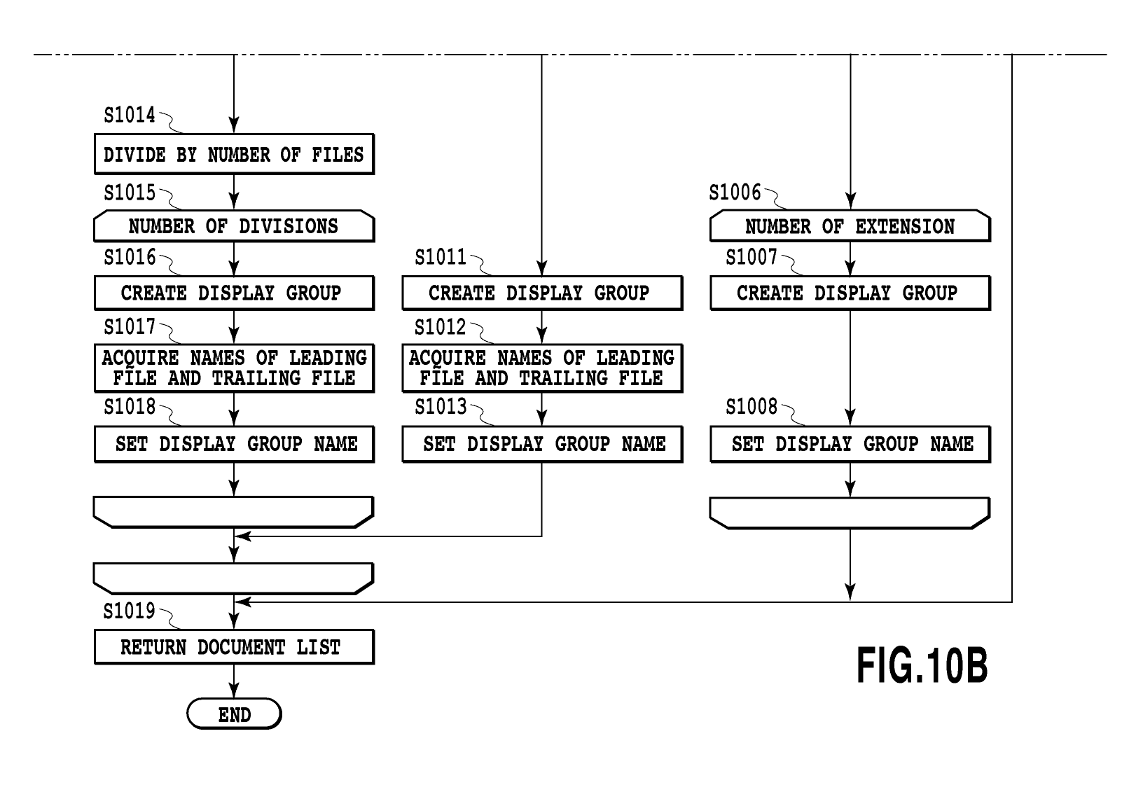

FIG. 10 is a flow chart of processing performed by the server 203 in order to create a display group in accordance with sort. A CPU (processor) of the server 203 expands to a RAM a program stored in a storage section such as an HDD, and the processing is controlled in accordance with the program. The processing shown in this flow chart is described focusing on an example when documents are sorted by the extensions indicated by the numerals 742 and 744 of FIG. 7.

First, document files stored in the storage device 104 of the server 203 are sorted by index items specified by a user, and a list of the document files aligned in a sort order is acquired (S1001). It is determined whether or not the number of acquired files are more than a threshold value (S1002), and if they are less, the list of the document files acquired in S1001 is returned as it is as a document list (it is transmitted to the client PC 202 or the video interface 105) (S1019).

When the number of files are more than the threshold value, a display group is created. As shown in FIG. 7, since a display group differs depending on a sort key (an index item used for sort), a data type regarding the sort key used for sort is first determined (S1003). Hereinafter, processing when an extension having a data type of selection type is specified as the sort key will be described as an example, and a description of processing regarding other sort keys such as a text type, will be omitted.

When a sort key is an extension, the document lists acquired in S1001 are classified for each extension (S1004). Next, a specified type of collection method is determined (S1005), and a display group is created depending on the type of collection method. A determination of the collection method in S1005 may be made by a set value, or may be determined from a balance of the number of options (the number of types of extensions) and the number of files. For example, when there are a number of types of extensions and document files, and the number of display groups is more than the threshold value when they are displayed in one stage, it can be considered that the display groups are displayed by two stages of display groups.

When options (extensions) are selected as the collection method in S1005, extensions are selected one by one and processing in S1007 to S1008 is performed repeatedly as shown with a loop end in S1006. That is, a display group for each extension is created (S1007), an extension name is set as a display group name (S1008), and the set display group name is returned as a document list (S1019).

In addition, when “option (extension)+the number of files” is selected in S1005, extensions are selected one by one and processing in S1010 to S1018 is performed repeatedly as shown with a loop end in S1009. That is, processing in S1010 to S1018 is repeated by the number of types of extensions of the files. In S1010, it is determined whether or not the number of files of the extension selected as a target to be processed in S1009 is more than the threshold value. When it is determined that the number of files of the extension under selection is not more than the threshold value, a display group of the extension is created (S1011). Leading file and trailing file names which are included in the display group are acquired (S1012), and a display group name is set from the extension, and the leading file and trailing file names (S1013).

In contrast, when it is determined that the number of files of the extension under selection is more than the threshold value in S1010, file groups having the extension are further divided by the number of files (S1014). Then, the file groups divided in S1014 are selected one by one, and processing in S1016 to S1018 is performed repeatedly as shown with a loop end in S1015. Here, a display group is created based on a divided file group under selection (S1016), leading file and trailing file names which are included in the display group are acquired (S1017), and a display group name is set (S1018).

Subsequently, a created display group is returned as a document list (S1019). It should be noted that a flow of creating a display group is one example, and a different processing flow may be employed depending on a data configuration of the document management server.

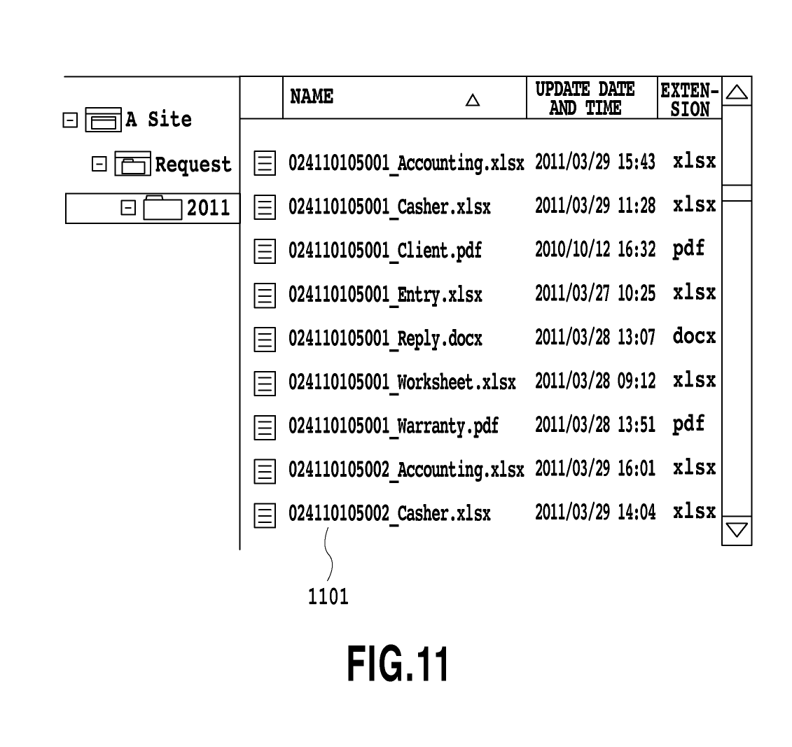

Although creation of the display group in accordance with sort has been described using FIGS. 4 to 10, the display group by sort may not necessarily be desirable. For example, a case shown in FIG. 11 can be considered.

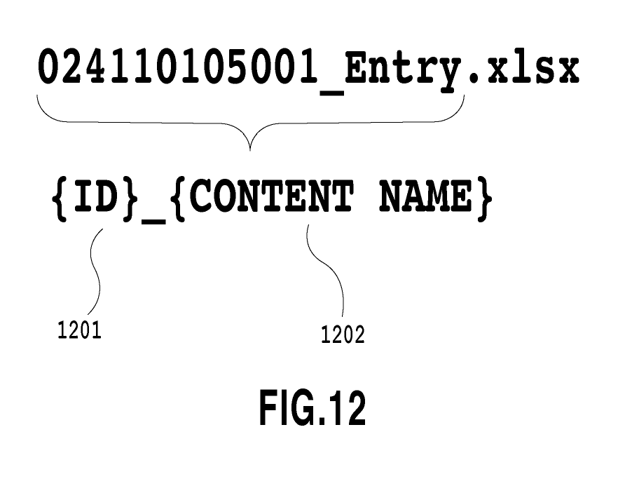

In a document list 1101 of FIG. 11, an ID is set as a document name of a document, and document files are associated by the ID. In such a case, optimal grouping is not performed in creation of a display group based on an extension or an update date and time, and thus an effective display group cannot be created. In such case, a display group is created based on the name of a document. A case where a display group is created from a name of a document will be described using FIGS. 12 to 14.

FIG. 12 is an example where a naming rule of documents stored in the storage section of the document management server is defined. A document name has an ID 1201 in the lead thereof and a character string 1202 representing a content in the rear thereof, and they are connected by an under bar. The ID1201 serves as a key for creating a display group. Meanwhile, the character string 1202 can be arbitrarily specified, and is not involved in creation of the display group. In addition, although a simple definition using only an ID is employed in FIG. 12, it is also possible to define a plurality of other keys and to define a document name.

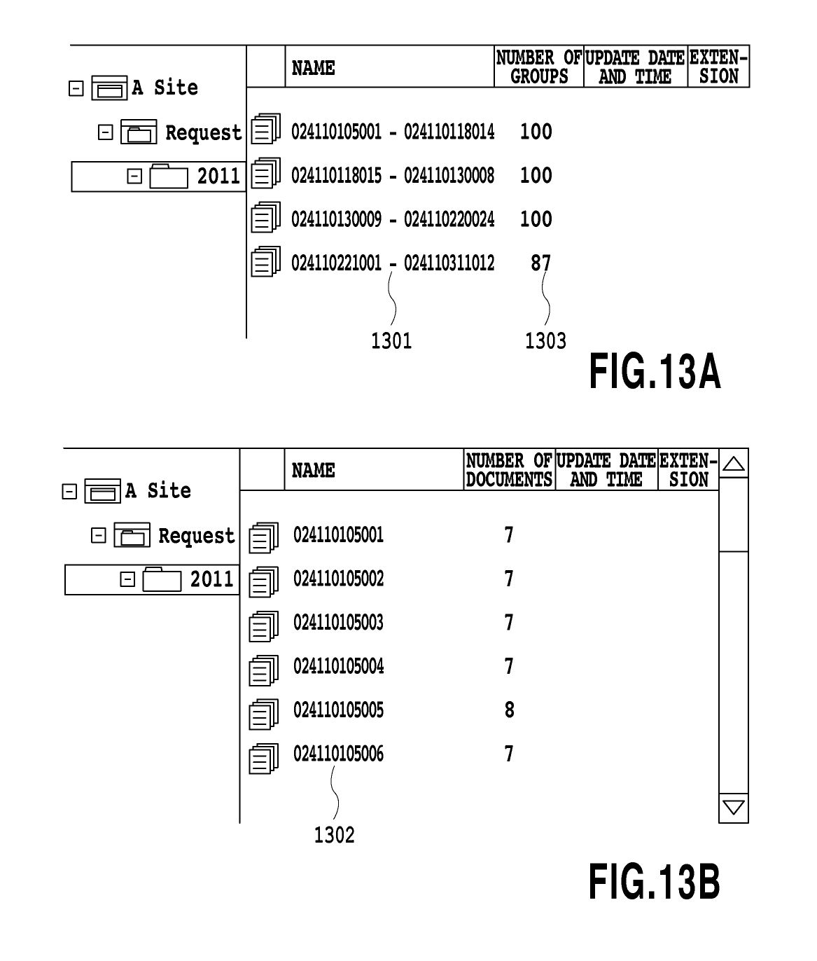

FIG. 13 shows an example of display groups created based on configurations of document names. The file name defined in FIG. 12 is first collected by the ID 1201 and further, the collected number of display groups is divided and collected for each hundred groups.

In FIG. 13A, a document list 1301 indicates a display group list in which documents have been collected for each hundred groups. Each display group name represents a range of collected IDs. That is, each display group name is determined in accordance with a configuration of a part of a document name.

When a leading display group of the document list 1301 is expanded, a display group grouped for each ID is displayed as in a document list 1302 in FIG. 13B. The ID 1201 is set as a name in each display group of the document list 1302. When each display group of the document list 1302 is expanded, document files associated by ID1201 are displayed. As described above, by creating the display group in two stages, a document list easy to be accessed can be made. It should be noted that although the number of documents 1303 in FIG. 13A is employed as an example indicating the number of display groups directly below, it may indicate the number of document files.

That is, in the examples shown in FIGS. 11 to 13, files stored in the storage section of the server are grouped into a first display group in accordance with configurations of file names, and the first display group is grouped into a second display group by the predetermined number of groups (for example, a hundred groups). Names of the first and the second display groups are determined in accordance with configurations of file names of files included in each display group.

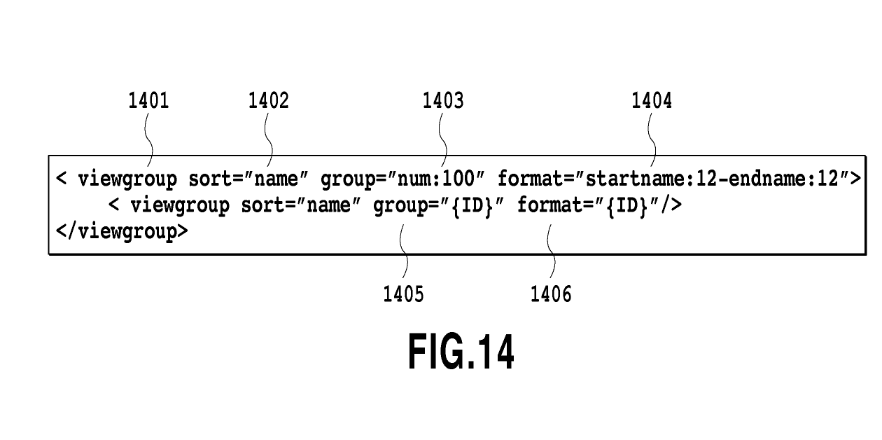

FIG. 14 is a file in which a creation method of a display group is defined. Viewgroup tags of a numeral 1401 are the tags which define display groups, and they can be hierarchized. Here, the viewgroup tags are arranged in two hierarchies, which defines the fact that display groups are created in two hierarchies as in FIG. 13.

A sort attribute of a numeral 1402 indicates a sort order in display groups being displayed on the client PC. Even when display groups are created from definition of document names, the display groups are displayed in accordance with the specified sort order in displayed on the client. A name, which is a value of a sort attribute here, indicates that documents are sorted by document names.

A group attribute of a numeral 1403 defines a collection method. num: 100 denotes collection for each hundred document files.

A format attribute of a numeral 1404 indicates a display group name. “startname:12-endname:12” indicates that twelve characters of a leading document name (or a leading display group name) and twelve characters of a trailing document name (or a trailing display group name) are connected by a hyphen to be displayed. A document list shown in FIG. 13A is created by viewgroup tags from these numerals 1401 to 1404.

A document list in FIG. 13B are defined by nested viewgroup tags. {ID} of a group attribute 1405 works with the ID 1201 of FIG. 12, and indicates that documents are grouped by IDs of document names. A format attribute 1406 indicates that IDs are set as display group names.

A document name definition of FIG. 12 and a definition of a display group creation method of FIG. 14 can be set for each storage area of the document management server, and they can define various creation methods of a display group depending on a storage area of a document. In addition, when there is no particular definition, creation of a display group in accordance with sort is performed.

As described above, by creating an optimal display group in accordance with the storage area of the document or sort, it is possible to provide document lists a user easily accesses even when there exist a large amount of documents.

Although the embodiment in which display groups are created has been described above, the configuration may be such that all the document files are not grouped. When display groups are created so that all the documents are included in any of the display groups, the number of times of user operation increases since operation of expanding a display group is certainly needed in the user accessing a document. Consequently, a document more likely to be accessed (that is, accessed with a high priority) is not made into a target to be grouped, and it may be displayed as it is.

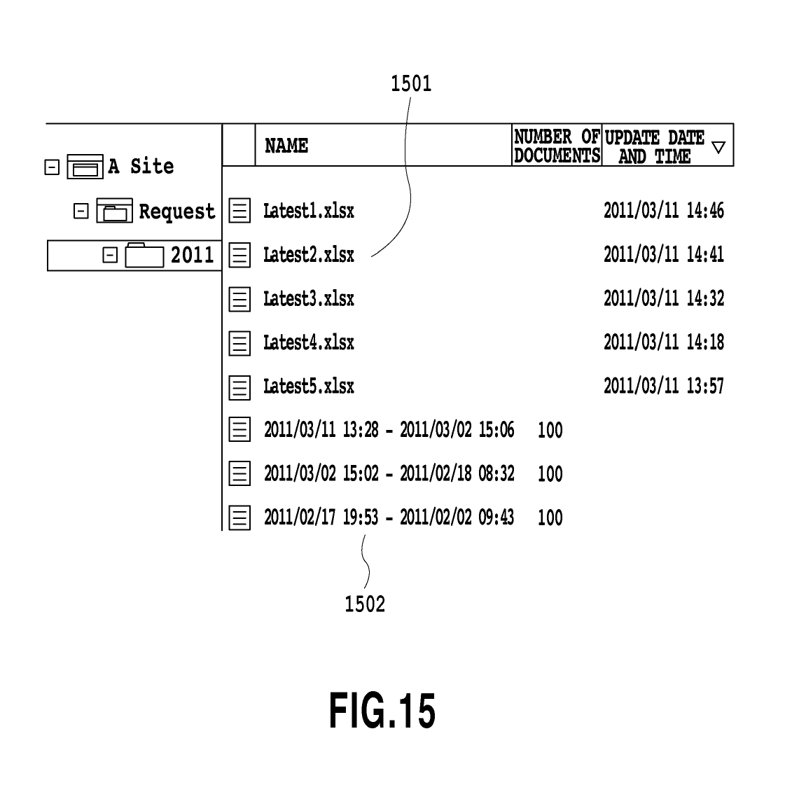

FIG. 15 shows an example when documents are sorted by update dates and times. A newest document is more likely to be accessed since documents are sorted by update dates and times, and five document files 1501 on the upper side of a document list are displayed without being grouped. That is, document files with new update dates and times are not included in targets to be grouped. Subsequently, remaining document files other than the document files 1501 are grouped, and they are displayed on the list as a display group 1502.

It should be noted that although it is determined that, in FIG. 15, a document is more likely to be accessed from a sort item of update date and time, the determination may also be made based on other priority and ranking such as the number of accesses. In addition, the number of document files which are not grouped into display groups may also be determined suitably.

As a result, a document list can be provided without impairing access to a document more likely to be accessed.

### Other Examples

In addition, the present invention is achieved also by executing the following processing. That is, the processing means the processing in which a software (program) which achieves functions of the above-mentioned embodiment is supplied to a system or a device via a network or various storage media, and a computer (or a CPU, an MPU, etc.) of the system or the device read the program for execution.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-195399, filed Sep. 7, 2011, which is hereby incorporated by reference herein in its entirety.

What is claimed is:

1. An information processing device having a storage section and a processor, comprising:
a grouping unit configured to group a file stored in the storage section into a first group in accordance with a feature of the file and to group the file of the first group into a second group by a predetermined number of files, by the processor; and
a naming unit configured to determine names of the first and the second groups in accordance with the feature of the file included in the groups by the processor.

2. The information processing device according to claim 1, wherein
the feature of the file for grouping is a file type, and wherein
a name of the first group is determined in accordance with the file type.

3. The information processing device according to claim 2, wherein a name of the second group is determined in accordance with a file name.

4. The information processing device according to claim 1, wherein
the feature of the file for grouping is an initial of a file name, and wherein
a name of the first group is determined in accordance with the initial of the file name.

5. The information processing device according to claim 4, wherein a name of the second group is determined in accordance with an initial and a subsequent character of a file name.

6. The information processing device according to claim 1, wherein
the feature of the file for grouping is an update date and time, and wherein
names of the first and the second groups are determined in accordance with the update date and time.

7. An information processing device having a storage section and a processor, comprising:
a grouping unit configured to sort a file stored in the storage section by a feature of the file and to group the sorted file by the predetermined number of files, by the processor; and
a naming unit configured to determine a group name in accordance with the feature of the file included in the group by the processor.

8. The information processing device according to claim 7, wherein
the sort is performed by a file name, and wherein
the group name is determined in accordance with the file name.

9. The information processing device according to claim 7, wherein
the sort is performed by an update date and time of the file, and wherein
the group name is determined in accordance with the update date and time of the file.

10. The information processing device according to claim 7, wherein
the sort is performed by a file size, and wherein
the group name is determined in accordance with the file size.

11. An information processing device having a storage section and a processor, comprising:
a grouping unit configured to group a file stored in the storage section into a first group in accordance with a configuration of a file name and to group the first group into a second group by the predetermined number of groups by the processor; and
a naming unit configured to determine names of the first and the second groups in accordance with the configuration of the file name of the file included in the groups by the processor.

12. The information processing device according to claim 1, wherein a file with a new update date and time is not included in the group.

13. The information processing device according to claim 1, comprising a display unit configured to display the group name by a tree structure.

14. The information processing device according to claim 1, comprising a transmission unit configured to transmit the group name.

15. A method implemented in an information processing device having a storage section and a processor, the method comprising:
a grouping step of grouping a file stored in the storage section into a first group in accordance with a feature of the file and further grouping the file of the first group into a second group by the predetermined number of files, by the processor; and
a naming step of determining names of the first and the second groups in accordance with the feature of the file included in the groups by the processor.

16. A method implemented in an information processing device having a storage section and a processor, the method comprising:
a grouping step of sorting a file stored in the storage section by a feature of the file to group the sorted file by the predetermined number of files, by the processor; and
a naming step of determining a group name in accordance with the feature of the file included in the group by the processor.

17. A method implemented in an information processing device having a storage section and a processor, the method comprising:
a grouping step of grouping a file stored in the storage section into a first group in accordance with a configuration of a file name and grouping the first group into a second group by the predetermined number of groups, by the processor; and
a naming step of determining names of the first and the second groups in accordance with the configuration of the file name of the file, included in the groups by the processor.

18. A program for causing a computer to function as an information processing device according to claim 1.
